(19) United States
(12) Patent Application Publication
(10) Pub. No.: US 2010/0182467 A1
(43) Pub. Date: Jul. 22, 2010

(54) UNIT PIXEL HAVING 2-TRANSISTOR STRUCTURE FOR IMAGE SENSOR AND MANUFACTURING METHOD THEREOF

(75) Inventor: Do Young Lee, Seongnam-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: SILICONFILE TECHNOLOGIES INC., Seoul (KR)

(21) Appl. No.: 11/993,124

(22) PCT Filed: Jun. 21, 2006
(86) PCT No.: PCT/KR06/02379

§ 371 Date: Dec. 19, 2007

(30) Foreign Application Priority Data
Jun. 28, 2005 (KR) 10-2005-0056037

(51) Int. Cl. H04N 5/335

(52) U.S. Cl. 348/294

(57) ABSTRACT

A unit pixel having a pixel constructed with a photodiode and a 2-transistor for an image sensor is disclosed. The unit pixel having a 2-transistor structure for an image sensor includes: a photodiode containing impurities having an opposite type of a semiconductor material; a reset transistor connected to the photodiode to initialize the photodiode; and a transistor having selecting and reading-out functions connected to the photodiode to have functions of controlling connection between a pixel and an external lead-out circuit and reading-out the information of the pixel. Accordingly, an aperture surface rises and a pixel size decreases, so that sensitivity increases. Also, the fill factor of the photodiode increases significantly due to a decrease of the number of the transistor, so that the sensitivity increases and costs reduce.

### TECHNICAL FIELD

The present invention relates to a unit pixel of an image sensor, and more particularly, to a unit pixel of image sensor in which a photodiode is separated from a pixel array region and a manufacturing method thereof.

### BACKGROUND ART

Pixels used in conventional image sensors are roughly classified into 3-transistor pixels, 4-transistor pixels, and 5-transistor pixels according to the number of transistors included therein.

FIGS. 1 to 3 show a typical pixel structure used for an image sensor, according to the number of transistors.

FIG. 1 shows a 3-transistor structure. FIGS. 2 and 3 show a 4-transistor structure.

As shown in FIGS. 1 to 3, a fill factor that is the area occupied by the photodiode over the entire area of the pixel is naturally reduced due to the existence of transistors in a pixel circuit. In general, the fill factor of a diode ranges from 20 to 45%, considering capability of each semiconductor manufacturing process. Accordingly, light that is incident onto the rest area corresponding to about 55-80% of the entire area of the pixel is lost.

To minimize the loss of optical data, a microlens is used for each unit pixel in a manufacturing process of the image sensor so that the optical data can be condensed onto the photodiode of each pixel. A microlens gain is defined as an increment of the sensitivity of a sensor using the microlens with respect to the sensitivity of the image sensor without the microlens.

Given that the fill factor of a common diode is about 30s %, the microlens gain is 2.5-2.8 times of the sensitivity of the image sensor without the microlens. However, a pixel size has decreased to 4 μm×4 μm, and even to 3 μm×3 μm. Further, with an emergence of a small-sized pixel of 2.8 μm×2.8 μm or 2.5 μm×2.5 μm, starting from when the pixel size is 3.4 μm×3.4 μm, the microlens gain significantly drops from 2.8 times to 1.2 times of the sensitivity of the image sensor without the microlens. This is caused by diffraction phenomenon of the microlens. The level of diffraction phenomenon is determined by a function of a pixel size and a position of the microlens.

As the pixel size gradually decreases, the diffraction phenomenon of the microlens becomes more severe, thereby dropping the microlens gain equal to or less than 1.2 times of the sensitivity of the image sensor, which results in a phenomenon where the light condensation seems to be unavailable. This is newly being recognized as a cause of sensitivity deterioration.

In general the decrease of the pixel size for the image sensor results in the decrease of the area for the photodiode. The area of the photodiode is closely related to the amount of available electric charge of the photodiode. Accordingly the amount of available electric charge decreases when the size of the photodiode decreases. The amount of available electric charge of the photodiode is a basic feature of determining a dynamic range of the image sensor, and therefore the decrease of the amount of available electric charge directly affects the image quality of the sensor. When the image sensor of which the pixel size is less than 3.2 μm×3.2 μm is manufactured, its sensitivity decreases, and the dynamic range of the sensor with respect to the light also decreases, thereby deteriorating the image quality.

An external lens is used in the process of manufacturing a camera module using the image sensor. In this case, light is substantially vertically incident onto a center portion of a pixel array. However, the light is less vertically incident onto edge portions of the pixel array. When an angle starts to deviate from the vertical angle by a predetermined degree, the light is condensed onto the microlens which is out of the area pre-assigned for condensation for the photodiode. This causes a dark image, and more seriously, when the light is condensed onto a photodiode of an adjacent pixel, chromaticity may change.

Recently, with the development of the image sensor having from 0.3 million pixels and 1.3 million pixel to 2 million pixels and 3 million pixels, a dynamic zoom-in/zoom-out function as well as an automatic focus function are expected to be included in a mini camera module.

The feature of the functions lie in that the incident angle of the light Significantly changes at edge portions while each function is performed. The chromaticity or brightness of the sensor has to be independent of changes in the incident angle. With the decrease of the pixel size, however, the sensor cannot cope with the changes in the incident angle. At present, the sensor can handle the automatic focus function, but the dynamic zoom-in/zoom-out function is not available yet. Therefore, it is difficult to develop a mini camera module providing a zoom function.

### DETAILED DESCRIPTION OF THE INVENTION

### Technical Goal of the invention

In order to solve, the aforementioned problems, an object of the present invention is to provide a unit pixel having a 2-transistor structure for an image sensor of which sensitivity drops far lesser than a conventional case in the manufacturing of a miniature pixel, capable of handling light incident onto a photodiode at various angles.

### DISCLOSURE OF THE INVENTION

According to an aspect of the present invention, there is provided a unit pixel having a 2-transistor structure for an image sensor including: a photodiode containing impurities having an opposite type of semiconductor material; a reset transistor connected to the photodiode to initialize the photodiode; and a selection transistor connected to the photodiode to have functions of controlling connection between a pixel and an external lead-out circuit and heading-out the information of the pixel.

### BRIEF DESCRIPTION OF THE DRAWINGS

FIGS. 1 to 3 show a structure of a pixel according to the number of transistors typically used for an image sensor;

FIG. 4 shows a unit pixel having a 2-transistor structure for an image sensor according to an embodiment of the present invention;

FIG. 5 shows a unit pixel having a 2-transistor structure for an image sensor according to another embodiment of the present invention;

FIG. 6 shows a plurality of unit pixels connected with each other in an image sensor having a pixel array region constructed with 2-transistors according to another embodiment of the present invention;

FIG. 7 shows a timing diagram showing operations of the FIG. 6;

FIG. 8 shows a physical structure of a unit pixel having a 2-transistor structure for an image sensor according to an embodiment of the present invention; and

FIG. 9 shows a physical structure of a unit pixel having a 2-transistor structure for an image sensor according to another embodiment of the present invention.

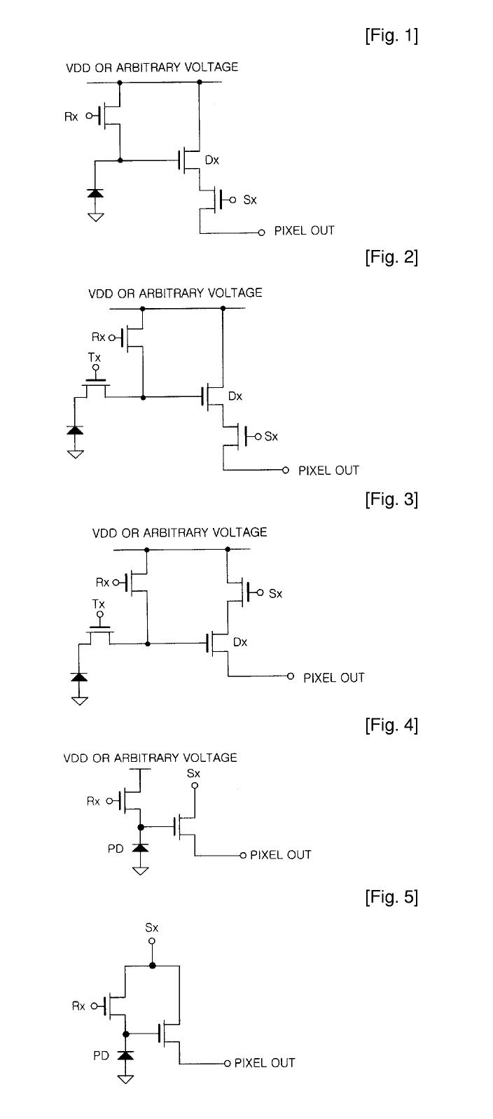

### BEST MODE FOR CARRYING OUT THE INVENTION

Hereinafter, the present will be described in detail with reference to accompanying drawings.

FIG. 4 shows a unit pixel having a 2-transistor structure for an image sensor according to an embodiment of the present invention, the unit pixel includes a photodiode PD, a reset transistor Rx, and a transistor having selecting and reading-out functions Sx.

A cathode electrode of the photodiode containing impurities having an opposite type of a semiconductor material is connected to a source electrode of the reset transistor Rx and a gate electrode of the transistor having selecting and reading-out functions Sx.

The reset transistor Rx initializes the photodiode PD and the transistor Sx having selection/reading-out function has functions of controlling connection between a pixel and an external lead-out circuit and reading-out the information of the pixel.

The reset transistor Rx and the transistor Sx having selection/reading-out function may be applied with different voltage sources.

FIG. 5 shows a unit pixel having a 2-transistor structure for an image sensor according to another embodiment of the present invention, the unit pixel includes a photodiode PD, a reset transistor Rx, and a transistor having selecting and reading-out functions Sx.

A cathode electrode of the photodiode containing impurities having, an opposite type of a semiconductor material is connected to a source electrode of the reset transistor Rx and a gate electrode of the transistor having selecting and reading-out functions Sx.

A drain electrode of the reset transistor Rx and a drain electrode of the transistor Sx having selection/reading-out function are connected with each other, and a common voltage source is applied thereto.

The reset transistor Rx initializes the photodiode and the transistor Sx having selection/reading-out function has a function of controlling connection between a pixel and an external lead-out circuit to provide, the information of the pixel to the external lead-out circuit.

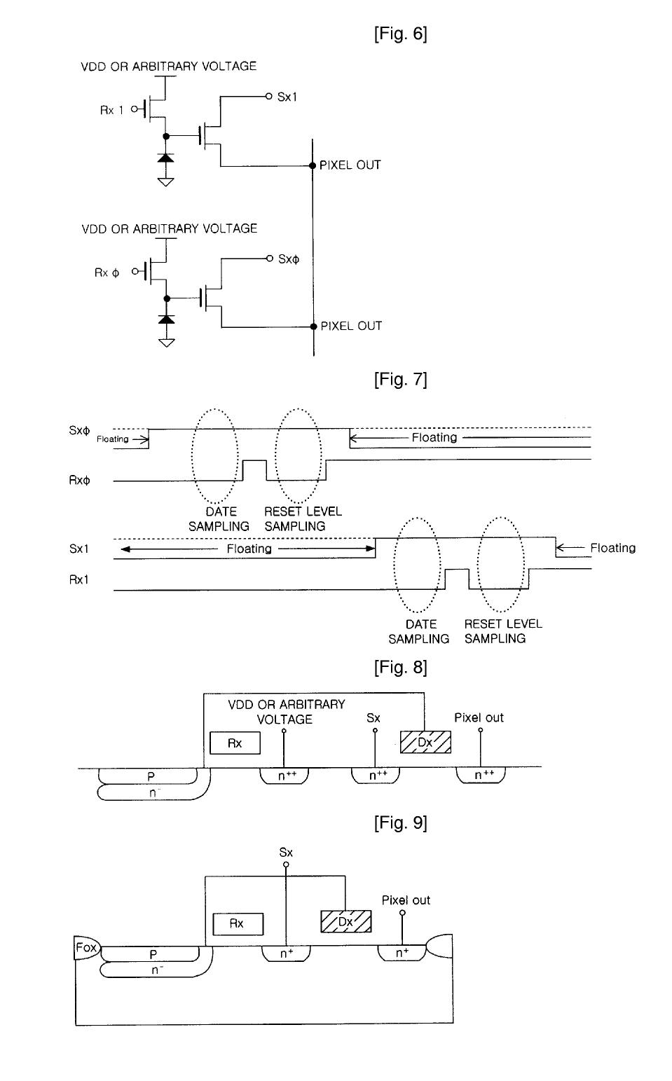

FIG. 6 shows a plurality of unit pixels connected with each other in an image sensor having a pixel array region constructed with 2-transistors according to another embodiment of the present invention, pixel outputs of the plurality of unit pixels are connected with each other.

FIG. 7 shows a timing diagram showing operations of the FIG. 6.

A VDD (voltage source) or an arbitrary voltage is applied to lines only when lines are read. A current supply is controlled by a line selection signal.

FIG. 8 shows a physical structure of a unit pixel having a 2-transistor structure for an image sensor according to an embodiment of the present invention.

In as p-type semiconductor substrate, a positive-negative (PN) junction is formed to form the photodiode PD and a gate electrode of the reset transistor Rx for initializing the photodiode is formed. Also, the VDD or the arbitrary voltage for applying an addressing signal to the drain electrode of the reset transistor Rx is applied to the drain electrode of the reset transistor Rx and the transistor Sx having selection/reading-out function for applying the information of the photodiode PD to the gate electrode of the transistor Sx having selection/reading-out function is formed.

FIG. 9 shows a physical structure of a unit pixel having a 2-transistor structure for an image sensor according to another embodiment of the present invention.

In a p-type semiconductor substrate, a PN junction is formed to form the photodiode PD and a gate electrode of the reset transistor Rx for initializing the photodiode is formed. Also, the transistor Sx having selection/reading-out function for applying an addressing signal to the drain electrode of the transistor having selecting and reading-out functions and also applying the information of the photodiode PD to the gate electrode of the transistor Sx having selection/reading-out function is formed. The reset transistor Rx and the transistor Sx having selection/reading-out function have a common junction layer.

While the present invention has been particularly shown and described with reference to exemplary embodiments thereof, it will be understood by those of ordinary skill in the art that various: changes in form and details may be made therein without departing from the spirit and scope of the present invention as defined by the following claims.

### INDUSTRIAL APPLICABILITY

Accordingly, the present invention has advantages in that, an aperture surface rises and a pixel size decreases, so that sensitivity increases. Also, the fill factor of the photodiode increases significantly due to a decrease of the number of the transistor, so that the sensitivity increases and costs reduce.

1. A unit pixel having a 2-transistor structure for an image sensor comprising:
a photodiode containing impurities having an opposite type of a semiconductor material;
a reset transistor connected to the photodiode to initialize the photodiode; and
a transistor having selecting and reading-out functions connected to the photodiode to have functions of controlling connection between a pixel and an external lead-out circuit and reading-out the information of the pixel.

2. The unit pixel having a 2-transistor structure for an image sensor according to claim 1, wherein the reset transistor and the transistor having selecting and reading-out functions of which lines are applied with a VDD (voltage source) or an arbitrary voltage only when the reset transistor and the transistor having selecting and reading-out functions read lines.

3. The unit pixel having a 2-transistor structure for an image sensor according to claim 1, wherein the reset transistor and the transistor having selecting and reading-out functions have a common junction layer.
